(19) United States
(12) Patent Application Publication
(10) Pub. No.: US 2025/0060598 A1
(43) Pub. Date: Feb. 20, 2025

(54) ELECTRONIC DEVICE

(71) Applicant: Apple Inc., Cupertino, CA (US)

(72) Inventors: Alison B. Shutzberg, San Francisco, CA (US); Paul Williams, Seattle, WA (US)

(21) Appl. No.: 18/433,314

(22) Filed: Feb. 5, 2024

Related U.S. Application Data
(60) Provisional application No. 63/520,218, filed on Aug. 17, 2023.

(51) Int. Cl. G02B 27/01

(52) U.S. Cl. CPC G02B 27/0176; G02B 2027/0154; G02B 2027/0178

(57) ABSTRACT

An electronic device (e.g., a head-mountable electronic device) can include a viewing frame and a securement arm extending from the viewing frame. The securement arm can include a first portion, a joint, and a second portion coupled to the first portion at the joint. The second portion can have a resting position. The securement arm can further include a biasing member providing a biasing force resisting a movement of the second portion relative to the first portion, such as resisting a rotation of the second portion away from the frame. The biasing member can be configured to resist a movement of the second portion away from the resting position. The securement arm can further include an adjustment member configured to adjust the biasing force. The biasing member can have a preload, and the adjustment member can be configured to adjust the preload. Additional systems and methods are also disclosed.

### CROSS-REFERENCE TO RELATED APPLICATION(S)

This claims priority to U.S. Provisional Patent Application No. 63/520,218 filed 17 Aug. 2023, and entitled “ELECTRONIC DEVICE,” the entire disclosure of which is hereby incorporated by reference in its entirety.

### FIELD

The described examples relate generally to electronic devices. More particularly, the present examples relate to head-mountable electronic devices.

### BACKGROUND

Recent advances in portable computing have enabled head-mountable devices that provide augmented and virtual reality experiences to users. Various component of these devices, such as display screens, viewing frames, securement arms, speakers, batteries, and other components, operate together to provide an immersive and comfortable experience. However, the anatomy of each user's head is unique. One user's head can be larger than another user's head, or one head can be a different shape. Other anatomical features, including relative positions of a user's nose, forehead, and ears, can vary widely between users as well. The anatomical variety of heads presents a challenge for head-mountable devices designed for comfort and reliability.

In some head-mountable devices, for example, securement arms that extend along, or make contact with, opposing sides of a user's head can be used to secure the device to the user's head. However, the dimensions, angles, shape, and other physical characteristics of the arms that may be sufficient to comfortably and reliably secure the device to one user's head may not be sufficient to comfortably and reliably secure the device to another user's head.

Additionally, head-mountable devices can be used in a variety of different settings and during a variety of different activities. These can range from lying down still in bed to mountain biking or hiking outdoors. Thus, even for a single user, the securement arms of a head-mountable device that are comfortable and sufficient for securing the device during one activity may not be comfortable or sufficient for another activity.

Therefore, a need exists in the art for an electronic device (e.g., a head-mountable device) that addresses the above deficiencies or at least offers an alternative to current systems and devices.

### SUMMARY

Various examples of the present disclosure include a securement arm for a wearable device. The securement arm can include a first portion, a joint, and a second portion coupled to the first portion at the joint. The securement arm can further include a biasing member providing a biasing force resisting a movement of the second portion relative to the first portion. The securement arm can further include an adjustment member configured to adjust the biasing force.

In one example, the adjustment member can include a body slidable along a length of one of the first portion or the second portion to adjust the biasing force. In one example, the biasing member can have a spring rate. The body can include a block slidably coupled to the one of the first portion or the second portion to adjust the spring rate. In one example, the biasing member can include a bending beam having an effective length. The effective length can be adjusted based on a position of the block along the one of the first portion or the second portion. In one example, a movement of the body away from the joint can decrease the biasing force. In one example, the joint can include a living hinge. The biasing member can include an elastic member. In one example, a head-mountable device can include the securement arm. The securement arm can be a first securement arm, and the head-mountable device can include a frame and a second securement arm, the first and second securement arms extending from the frame. In one example, the head-mountable device can be a head-mountable electronic device.

Various examples of the present disclosure include an electronic device. The electronic device can include a viewing frame, a window disposed in the viewing frame, and a securement arm extending from the viewing frame. The securement arm can include a first portion, a joint, and a second portion coupled to the first portion at the joint, the second portion having a resting position. The securement arm can further include a biasing member having a preload and configured to resist a movement of the second portion away from the resting position. The securement arm can further include an adjustment member configured to adjust the preload.

In one example, the biasing member can be configured to resist an outward rotation of the second portion away from the viewing frame. In one example, the biasing member can include a flat spring having a spring rate. The adjustment member can include a block slidably coupled to one of the first portion or the second portion to adjust the spring rate. In one example, the biasing member can include an elastic member having a length. The adjustment member can be configured to adjust the length. In one example, the biasing member can have a spring rate. The adjustment member can include a screw configured to adjust the spring rate. In one example, the adjustment member can be configured to adjust a tension in the biasing member.

Various examples of the present disclosure include a head-mountable device. The head-mountable device can include a frame, and optically transparent window secured to the frame, and a pair of securement arms extending from the frame. Each securement arm of the pair of securement arms can include a first portion coupled to the frame, a second portion, and a joint coupling the second portion to the first portion. Each securement arm can further include a biasing member providing a force resisting a rotation of the second portion away from the frame. Each securement arm can further include an adjustment member configured to adjust the force.

In one example, the adjustment member can include a body selectively positioned along a length of one of the first portion or the second portion to adjust the force. The head-mountable device can include a locking mechanism releasably securing the body in a selected position along the length. In one example, the joint can include a fixed pivot point for rotation of the second portion relative to the first portion. The biasing member can include a spring extending across the pivot point. In one example, the joint can include a living hinge. The biasing member can include a plate or wire resisting outward rotation of the second portion away from the frame. In one example, the head-mountable device can include a stop to limit inward rotation of the second portion towards the frame. In one example, an engagement of the second portion with the stop defines a resting position of the second portion relative to the first portion. The biasing member can resist a movement of the second portion away from the resting position.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a top view of an example of a head-mountable device worn by a user;

FIGS. 2A-2B illustrate top views of an example of a head-mountable device worn by a user;

FIG. 3 illustrates a side view of an example of a head-mountable device;

FIGS. 4A-4B illustrate side views of an example of a securement arm of a head-mountable device;

FIG. 5 illustrates a perspective view of an example of a securement arm of a head-mountable device;

FIGS. 6A-6C illustrate bottom views of an example of a securement arm of a head-mountable device;

FIG. 7A illustrates a perspective view of an example of a securement arm of a head-mountable device;

FIGS. 7B-7C illustrate cross-sectional views of the securement arm of FIG. 7A in bent and straight positions, respectively;

FIG. 8A illustrates a perspective view of an example of a securement arm of a head-mountable device;

FIG. 8B illustrates a cross-sectional view of the securement arm of FIG. 8A;

FIG. 9 illustrates a schematic view of an example of a securement arm of a head-mountable device;

FIG. 10 illustrates a schematic view of an example of a securement arm of a head-mountable device;

FIG. 11 illustrates a schematic view of an example of a securement arm of a head-mountable device; and

FIG. 12 illustrates a schematic view of an example of a securement arm of a head-mountable device.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described examples as defined by the appended claims.

The following disclosure relates to electronic devices. More particularly, the present disclosure relates to head-mountable electronic devices. In at least one example, a head-mountable device can include a viewing frame and a securement arm extending from the viewing frame. Examples of head-mountable devices can include optical devices (e.g., glasses, sunglasses, etc.) or virtual/augmented reality devices that include an optical component. In the case of augmented reality devices, optical eyeglasses can be worn on the head of a user such that optically transparent window, for example lenses and/or transparent optical displays, are positioned in front of the user's eyes. In another example, a virtual reality device can be worn on the head of a user such that a display screen is positioned in front of the user's eyes. The viewing frame can include a housing or other structural component supporting or housing the optical component, for example lenses or screens.

In a particular example, the head-mountable device can include a pair of securement arms extending from the frame. The pair of securement arms can apply pressure to or around a user's head to maintain the frame in position, such as in front of the user's eyes. In some examples, the securement arms can rest on top of the user's ears to assist in securing the head-mountable device to the head of the user.

In a particular example, the securement arm can include multiple portions or sections, and a joint allowing articulation of adjacent portions or sections. For example, the securement arm can include a first portion coupled to the frame, a second distal portion, and a joint coupling the second portion to the first portion. The joint can be a living hinge or can include a fixed pivot point for rotation of the second portion relative to the first portion, among other joint structures. A biasing member can provide a force resisting a movement of the second portion relative to the first portion, such as a rotation of the second portion away from the frame. An adjustment member can adjust the force, as desired.

In a particular example, the biasing member can be a spring or an elastic member having a spring rate. In one example, the biasing member can be a plate or wire. In another example, the biasing member can be a spring extending across the pivot point of the joint. In another example, the biasing member can be a fabric extending over the joint. Such examples are illustrative only, and the biasing member can include other configurations to resist movement of the second portion relative to the first portion. In each example, the biasing member can resist an outward movement of the second portion, such as by applying pressure to or around a user's head to maintain the head-mountable device in position.

In a particular example, the adjustment member can include a body slidable along a length of the first portion or the second portion to adjust the biasing member. In one example, the body can be selectively positioned along the length to adjust the spring rate of the biasing member. In an alternative example, the adjustment member can include a screw configured to adjust the spring rate. In at least one example, the adjustment member can adjust a preload or tension of the biasing member. For instance, the adjustment member can adjust a length (e.g., an effective length) or bend in the biasing member.

In a particular example, the second portion can have a resting position. In one example, the resting position can be defined by a stop limiting inward rotation of the second portion towards the frame. The biasing member can resist movement of the second portion away from the resting position, such as by resisting outward rotation of the second portion away from the viewing frame. In one example, the biasing member can set a preload or tension of the second portion against the stop.

Accordingly, examples of securement arms described in the present disclosure can provide secure and comfortable donning of head-mountable electronic devices for a wide range of user head sizes, shapes, and other head and face anatomical feature variations.

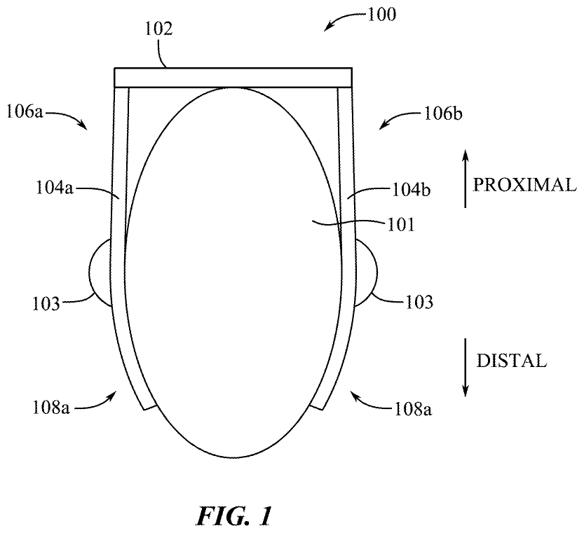

These and other examples are discussed below with reference to FIGS. 1-12. However, those skilled in the art will readily appreciate that the detailed description given herein with respect to these figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a top view of an example of a wearable device, for example a head-mountable device 100. The wearable head-mountable device 100 (hereinafter “device” for sake of convenience) can be any device or system configured to be worn on the head 101 of a user, such as a head-mountable electronic device, an optical device, and the like. Thus, the term “device” is used for sake of convenience without intent to limit. As shown, the device 100 can include a viewing frame 102 configured to secure one or more optically transparent windows, for example optical lenses or transparent display screens, in front of the eyes of the user. The device 100 can include one or more securement arms 104a, 104b (e.g., temple arms) extending from the viewing frame 102. For example, the device 100 can include a first securement arm 104a and a second securement arm 104b.

Each securement arm 104a or 104b can be secured to the viewing frame 102 and can extend (e.g., distally) toward the rear of the user's head 101. As shown, the securement arms 104a, 104b can extend over the user's ears 103 and curve along (e.g., adjacent) the user's head 101. The securement arms 104a, 104b can apply opposing pressures to the sides of the user's head 101, as shown, to secure the device 100 to the user's head 101. The securement arms 104a, 104b can also rest on the user's ears 103 and can secure the device 100 via friction between the securement arms 104a, 104b and the head 101.

In one example, the securement arms 104a, 104b can include a first portion 106a, 106b and a second portion 108a, 108b, respectively. The second portions 108a, 108b can be curved or disposed at an angle relative to the first portions 106a, 106b, such that at least portions of the securement arms 104a, 104b make contact along a length of the side of the user's head 101. In the illustrated example of FIG. 1, at least the second portions 108a, 108b of the securement arms 104a, 104b curve with the user's head 101 to make contact with the head 101. In addition, the securement arms 104a, 104b can extend distally and can curve around a portion of the back of user's head 101, as shown, to hook around the head 101 and prevent the viewing frame 102 from being pulled forward proximally off the face or head 101 of the user.

As can be appreciated, the head 101 of the user can be a unique shape and size with a unique position of each ear 103 such that the curvature of the securement arms 104a, 104b shown in FIG. 1 may not be a match for the curvature and anatomy of the head of a different user. In general, the hooked configuration of the securement arms 104a, 104b around the sides and rear of the head 101, in addition to the increased contact area and/or length between the securement arms 104a, 104b and head 101, resist the viewing frame 102 from being pulled off the user's head 101.

In at least one example, the first portions 106a, 106b can be referred to as proximal portions. In such an example, the second portions 108a, 108b can be referred to as distal portions. The terms “proximal” and “distal” can be used to reference the position of various components described herein relative to the viewing frame 102 of the device 100. The orientation of the “proximal” and “distal” directions is shown in FIG. 1.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

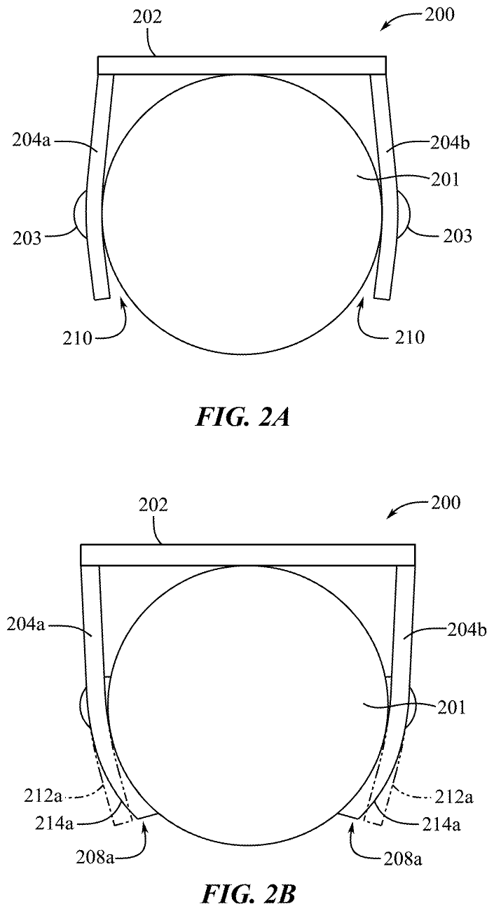

A user having a head 201 of a different size and shape as that of the head 101 shown in FIG. 1 is illustrated in FIGS. 2A-2B. Referring to FIG. 2A, the same or similar device 200 can include a viewing frame 202 secured, at least in part, to the user's head 201 via one or more securement arms 204a, 204b. As shown, the securement arms 204a, 204b can extend distally along opposing sides of the head 201. In the example shown, the arms 204a, 204b can extend over the user's ears 203 and toward the rear of the user's head 201. However, due to the shape of the user's head 201, the curvature of the arms 204a, 204b results in a gap 210 between the head 201 and the securement arms 204a, 204b.

Referring to FIG. 2B, in at least one example, the securement arms 204a, 204b can be configured to eliminate the gap 210 and increase the contact area and/or length between the securement arms 204a, 204b and the head 201. For example, the securement arms 204a, 204b can be reconfigured (e.g., automatically, manually) to hook further around the user's head 201 to more effectively secure the device 200 to the head 201. As shown in FIG. 2B, the securement arms 204a, 204b can include second portions 208a, 208b, respectively, that can be adjusted (e.g., automatically or manually) to curve with the profile and anatomical features of the user's head 201 as shown. First positions 212a, 212b of the second portions 208a, 208b, which result in the gap 210 shown in FIG. 2A, is shown in dotted lines. Adjusted second positions 214a, 214b of the second portions 208a, 208b are shown conforming to a curvature of the user's head 201. The second portions 208a, 208b can be adjusted by the user to accommodate the user's head 201 as shown to eliminate the gap 210 and more securely fasten or hold the device 200 onto the user's head 201.

Any of the features, components, and/or parts, including the arrangements and configurations thereof shown in FIGS. 2A-2B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 2A-2B.

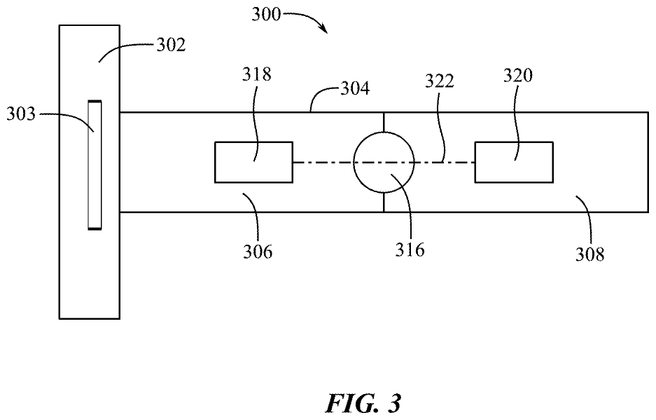

FIG. 3 illustrates a side view of an example of a device 300, including a viewing frame 302, and a securement arm 304 extending from the viewing frame 302. The securement arm 304 can be hingedly or rotatably attached to the viewing frame 302. In some examples, the securement arm 304 can be fixedly or unmovably attached or secured to the viewing frame 302. In at least one example, the securement arm 304 can include a first portion 306 and a second portion 308 rotatably connected to the first portion 306 at a joint 316. The first portion 306 can include a first electronic component 318. The second portion 308 can include a second electronic component 320. Additionally, at least one example can include an electronic circuitry component 322 extending through the joint 316 and electrically connecting the first electronic component 318 and the second electronic component 320.

As used herein, the term “joint” can refer to any structure coupling the second portion 308 to the first portion 306 and enabling one portion of the securement arm 304 to rotate or move relative to another portion, for example, the second portion 308 relative to the first portion 306. In one example, the first and second portions 306, 308 can be separate pieces such that the joint 316 includes one or more structures rotatably connecting both separate pieces. In some examples, the securement arm 304 can include first and second portions 306, 308 that are integrally formed as a unitary piece such that the joint 316 is defined by a portion or section of the unitary piece that allows the second portion 308 of the securement arm 304 on one side of the joint 316 to rotate relative to the first portion 306 on the other side of the joint 316. For example, the first and second portions 306, 308 can be formed as a single, unitary piece, and the joint 316 can include a reduced cross-section or flexible portion that allows the second portion 308 to rotate relative to the first portion 306 by bending at the joint 316. More details regarding various examples of joints and joint structures are given below with reference to other figures.

In one example, the first and second portions 306, 308 can extend along a major length of the securement arm 304 beginning proximally where the first portion 306 connects (either rigidly or rotatably) to the viewing frame 302 and extending distally towards the end of second portion 308. The length of the second portion 308 can be about 75% or less than the total major length of the securement arm 304. In one example, the second portion 308 can be about 60% or less or about 50% or less of the total major length of the securement arm 304. In one example, the second portion 308 can be about 40% or less, about 30% or less, about 20% or less, about 10% or less, or about 5% or less than the total major length of the securement arm 304. Correspondingly, the first portion 306 can be at least about 25% of the total major length of the securement arm 304 in one example, or at least about 40% of the total major length of the securement arm 304 in another example. In one or more other examples, the first portion 306 can be at least about 50%, at least about 60%, at least about 70%, at least about 80%, at least about 90%, or at least about 95% of the total major length of the securement arm 304.

The first and second electronic components 318, 320 can include any number of electronic components configured to operate and produce a virtual or augmented reality experience to the user through the device 300. For example, the first electronic component 318 can include a speaker, processor, projector, waveguide or memory component and the second electronic component 320 can include a battery or any other component including those described with reference to the first electronic component 318. In some examples, the electronic component 318 can include a projector and/or a waveguide configured to project and direct light toward and onto the optically transparent windows secured to the viewing frame 302. In examples where the second electronic component 320 includes a battery, the battery can be connected to the first electronic component 318 via the electronic circuitry component 322 to deliver power to the first electronic component 318.

The electronic circuitry component 322 can include one or more electrically conductive wires, flexes, resistors, circuit boards, or any other electronic circuitry components connecting the first electronic component 318 and the second electronic component 320. In one example, the securement arm 304 can include a housing defining an external surface and an interior volume. The first electronic component 318, the second electronic component 320, and/or the electronic circuitry component 322 can be disposed within the internal volume such that the components are hidden from view. Alternatively, one or more of the electronic components can be disposed on the housing. The electronic circuitry component 322 can extend through the joint 316 such that the functionality of the joint 316 and the electronic circuitry component 322 is not hindered.

In one example, the securement arm 304 can include one or more electronic components, including a first electronic component 318 and a second electronic component 320. The first electronic component 318 can include a projector, waveguide, speaker, processor, or memory component and the second electronic component 320 can include a battery or any other component including those described with reference to the first electronic component 318. In examples where the electronic component(s) 318, 320 includes a projector and/or a waveguide, the projector and/or waveguide can be configured to project and light that is display on a window 303 disposed in and/or secured to the frame 302. The window 303 can include an optically transparent material. The optically transparent window 303 can include an optical lens. The window 303 can include a transparent window through which light passes without redirecting light or vision correcting geometries. In examples where the second electronic component 320 includes a battery, the battery can be connected to the first electronic component 318 via the electronic circuitry 322 component to deliver power to the first electronic component 318.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

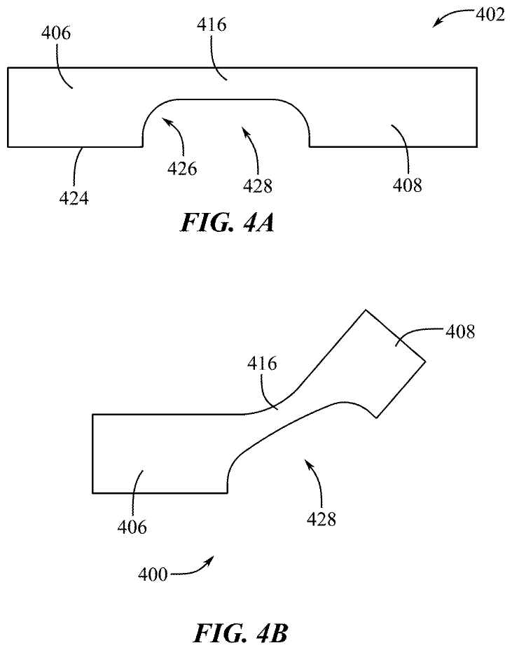

FIG. 4A illustrates a side view of another example of a securement arm 404, including a first portion 406 and a second portion 408 coupled to the first portion 406 at a joint 416. In the illustrated example, the joint 416 includes a notch 428 forming a reduced cross-sectional area of material at the joint 416. The reduced material of the securement arm 404 at the joint 416 forms a flexible portion of the securement arm 404 that can be bent to change the relative position and angle of the first and second portion 406, 408 of the securement arm 404. In the illustrated example, the notch 428 includes a cutaway feature removing material from the securement arm 404, although other configurations are contemplated.

In one example, the notch 428 cuts away at a housing 424 of the arm 404 such that the notch 428 extends into, exposes, and/or opens into an internal volume 426 of the securement arm 404 defined by the housing 424. In some examples, the cut away feature of the notch 428 does not open into an exposed internal volume 426. Rather, in some examples, the housing 424 forms the notch 428 such that a cross-sectional area or perimeter of the securement arm 404 at the joint 416 is reduced compared to the cross-sectional area or perimeter of the second portion 408 and/or the first portion 406 of the securement arm 404. In this way, the joint 416 forms a portion of the securement arm 404 that can more easily be bent or deformed by the user to manipulate and change the relative angle and position of the first portion 406 and the second portion 408.

In one example, the reduced cross-sectional area or perimeter of the securement arm 404 at the joint 416 can also reduce the strain of the material of the securement arm 404 and thus minimize the risk of fracture or cosmetic failure. The minimum cross-sectional area or perimeter of the securement arm 404 at the joint 416 can be as small as possible while accommodating the electrical or other functional components that may be disposed within the securement arm 404 at the joint 416 in one or more examples.

FIG. 4B illustrates a side view of the securement arm 404 shown in FIG. 4A but with the second portion 408 disposed at an angle relative to the first portion 406 via the joint 416. As noted, the joint 416 can be bent to reorient the second portion 408 relative to the first portion 406 as shown. The notch 428 can be altered to accommodate the bent joint 416.

Any of the features, components, and/or parts, including the arrangements and configurations thereof shown in FIGS. 4A-4B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 4A-4B.

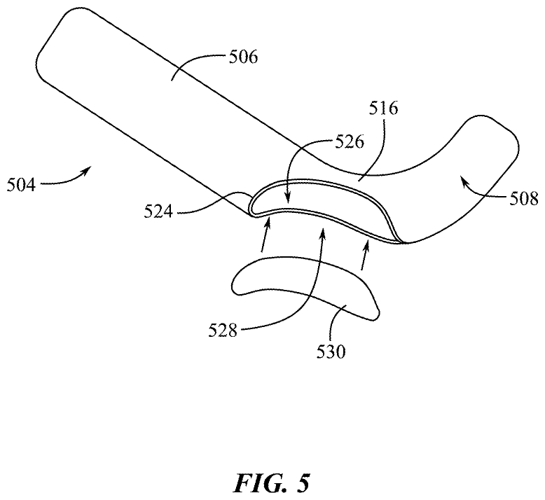

FIG. 5 illustrates a perspective view of another example of a securement arm 504, including a first portion 506, and a second portion 508 coupled to the first portion 506 at a joint 516. The joint 516 can include a cut away feature such as a notch 528 to reduce the cross-sectional area or perimeter of the material at the joint 516. The securement arm 504 can include a housing 524 defining an external surface and an internal volume 526 of the securement arm 504. In at least one example, the securement arm 504 can also be overmolded with a material at least in part defining a bias spring rate of the securement arm 504, including the spring rate at the joint 516 of the arm 504. In one example, the securement arm 504 can be overmolded with a material including a composite material, steel, bulk metallic glass, or the like, defining the biasing spring rate of the securement arm 504 at the joint 516.

Additionally, or alternatively, in at least one example, the securement arm 504, or the joint 516 of the securement arm 504, can include a biasing member 530 disposed at or near the joint 516 or as a part of the joint 516. The biasing member 530 can include an elastic material, including rubber, silicone, elastic polymers, or some combination of these or other elastic materials, disposed in the notch 528. FIG. 5 illustrates an exploded view of the securement arm 504 and the biasing member 530 with arrows indicating that the biasing member 530 can be disposed in the notch 528 and in contact with the housing 524. In at least one example, the biasing member 530 can be formed of silicone. In other examples, the biasing member 530 can be formed of one or more other elastic materials, including elastic polymer materials or various foam materials.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

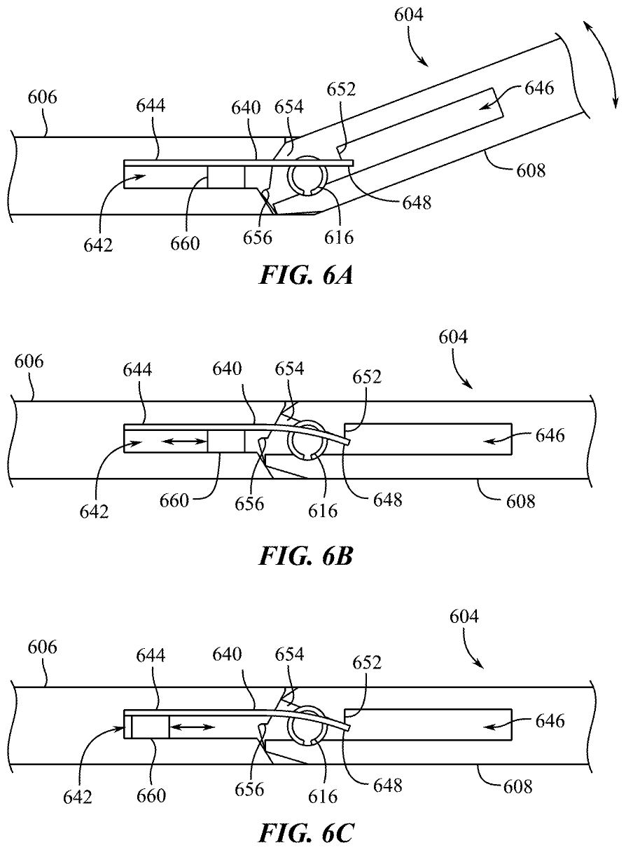

FIGS. 6A-6C illustrate another example of a securement arm 604, including a first portion 606 and a second portion 608 coupled to the first portion 606 at a joint 616. As shown, the joint 616 can include a fixed pivot point for rotation of the second portion 608 relative to the first portion. In one example, the securement arm 604 can include a biasing member 640. The biasing member 640 can provide a biasing force resisting a movement of the second portion 608 relative to the first portion 606. The biasing member 640 can provide a force resisting a rotation of the second portion 608 away from a frame (e.g., viewing frame 102, 202, or 302), although other configurations are contemplated. For instance, the biasing member 640 can be configured to resist an outward rotation of the second portion 608 away from the viewing frame of an associated device. The biasing member 640 can include any number of mechanisms, including springs and/or elastic materials, to bias the second portion 608 towards the side of a user's head, such as against the user's head to provide the necessary grip to hold an associated optical or head-mountable electronic device (e.g., device 100, 200, or 300) in place. In one example, the biasing member 640 can have a spring rate, which may be adjusted as detailed below. In one example, the biasing member 640 can allow the user to elastically expand the distance between opposing second portions 608 of a pair of securement arms 604 while donning and doffing the device before, after, and during use.

As shown, the first portion 606 can include a first slot 642 to receive the biasing member 640 (e.g., a first end 644 of the biasing member 640). The second portion 608 can also include a second slot 646 to receive the biasing member 640 (e.g., an opposing second end 648 of the biasing member 640). The first and second slots 642, 646 can be in communication with each other at the joint 616, such that the biasing member 640 extends across the joint 616. The first and second slots 642, 646 can be defined in the bottoms (or alternatively the tops) of the first and second portions 606, 608, respectively. Additionally, or alternatively, the first and second slots 642, 646 can be defined within respective interior volumes of the first and second portions 606, 608 (e.g., as defined by respective housings of the first and second portions 606, 608).

In one example, the second portion 608 can include a tab 652. In another example, the second portion 608 can include a first stop 654 and a second stop 656. In yet another example, the securement arm 604 can include an adjustment member 660 configured to adjust the biasing force provided by the biasing member 640. The adjustment member 660 can include a body slidable along a length of one of the first portion 606 or the second portion 608 to adjust the biasing force. For instance, the adjustment member 660 can include a block slidably coupled to the one of the first portion 606 or the second portion 608 to adjust the spring rate of the biasing member 640. In one example, the adjustment member 660 can linearly adjust along the first portion 606 or the second portion 608 to ease the spring force. As shown, the adjustment member 660 can be slidably coupled to the first portion 606, such as within the first slot 642.

In the example illustrated in FIGS. 6A-6C, the biasing member 640 can include a bending beam having an effective length, and in such examples, the effective length can be adjusted based on a position of the adjustment member 660 (e.g., block) along the first portion 606 or the second portion 608, as detailed below. Additionally, or alternatively, the biasing member 640 can include a flat spring having a spring rate, and in such examples, the adjustment member 660 (e.g., block) can be slidably coupled to the first portion 606 or the second portion 608 to adjust the spring rate. Additionally, or alternatively, the adjustment member 660 (e.g., body or block) can be selectively positioned along a length of the first portion 606 or the second portion 608 to adjust the force provided by the biasing member 640.

FIG. 6A illustrates the securement arm 604 in a first configuration, with the second portion 608 biased relative to the first portion 606 (e.g., inward toward the user's head, inward towards an opposing securement arm 606, etc.). As shown, the first stop 654 can be positioned against the biasing member 640 and/or the first portion 606 to define an innermost position of the second portion 608 relative to the first portion 606. In such position, the biasing member 660 configured as a bending beam can extend straight or substantially straight across the joint 616. In one example, the biasing member 640 can include a spring extending across the pivot point between the first portion 606 and the second portion 608.

FIG. 6B illustrates the securement arm 604 in a second configuration, with the second portion 608 moved (e.g., rotated) outwardly from the first configuration illustrated in FIG. 6A. When the second portion 608 is rotated outwardly, the biasing member 640 can bend across the joint 616. For instance, the tab 652 can press against the second end 648 of the biasing member 640 to create a bend in the biasing member 640 across the joint 616. In one example, the second portion 608 can rotate outwardly until the second stop 656 engages the biasing member 660 or a portion of the first portion 606, such as to define an outermost position of the second portion 608 relative to the first portion 606. As shown, the adjustment member 660 can be positioned near the joint 616 to increase the biasing force of the biasing member 640. For instance, positioning the adjustment member 660 near the joint 616 can reduce the effective length of the biasing member 640.

FIG. 6C illustrates the securement arm 604 in the second configuration and the adjustment member 660 positioned away from the joint 616. In one example, movement of the adjustment member 660 away from the joint 616 can decrease the biasing force of the biasing member 640. For instance, sliding the adjustment member 660 away from the joint 616 can increase the effective length of the biasing member 640. When an increased biasing force is desired, the adjustment member 660 can be slid towards the joint 616.

In one example, the securement arm 604 can include a locking mechanism releasably securing the adjustment member 660 (e.g., a body of the adjustment member 660) in a selected position along the length of the first portion 606 or the second portion 608. For instance, the first portion 606 can include multiple detents that releasably engage the adjustment member 660 in respective positions along the first slot 642. In another example, the adjustment member 660 can be releasably secured in place via one or more fasteners or engagement structures.

Any of the features, components, and/or parts, including the arrangements and configurations thereof shown in FIGS. 6A-6C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 6A-6C.

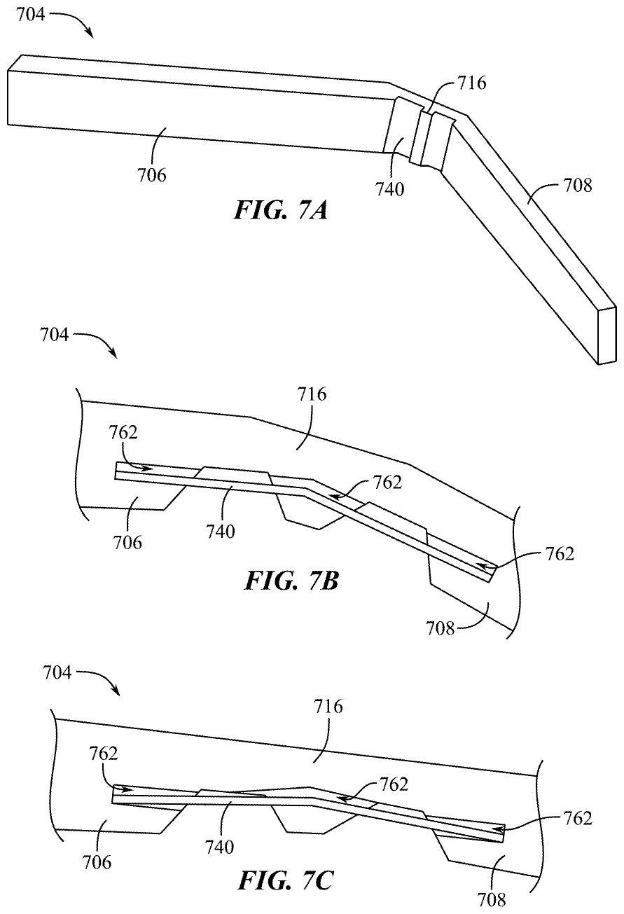

FIG. 7A illustrates another example of a securement arm 704, including a first portion 706 and a second portion 708 coupled to the first portion 706 at a joint 716. The joint 716 can include a living hinge in at least one example. For instance, the joint 716 can be a thin flexible hinge (or flexure bearing) made from the same material as the first portion 706 and the second portion 708. In one example, the joint 716 can be thinned or cut to allow the first and second portions 706, 708 to bend along the hinge. For instance, as shown, the joint 716 can include multiple (e.g., two or more than two) areas of reduced cross-section or thickness that allow the second portion 708 to rotate relative to the first portion 706.

FIGS. 7B-7C illustrate cross-sectional views of the securement arm 704 in bent and straight positions, respectively. As shown, the biasing member 740 can include a plate or wire resisting outward rotation of the second portion 708 away from an associated frame (e.g., frame 102, 202, or 302). In one example, the biasing member 740 can be positioned within one or more grooves 762 defined in the first portion 706, second portion 708, and joint 716. As the second portion 708 is rotated outwardly, the biasing member 740 can bear against the walls defining the grooves 762. In this manner, the biasing member 740 can provide a force resisting further outward rotation of the second portion 708 relative to the first portion 706.

Any of the features, components, and/or parts, including the arrangements and configurations thereof shown in FIGS. 7A-7C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 7A-7C.

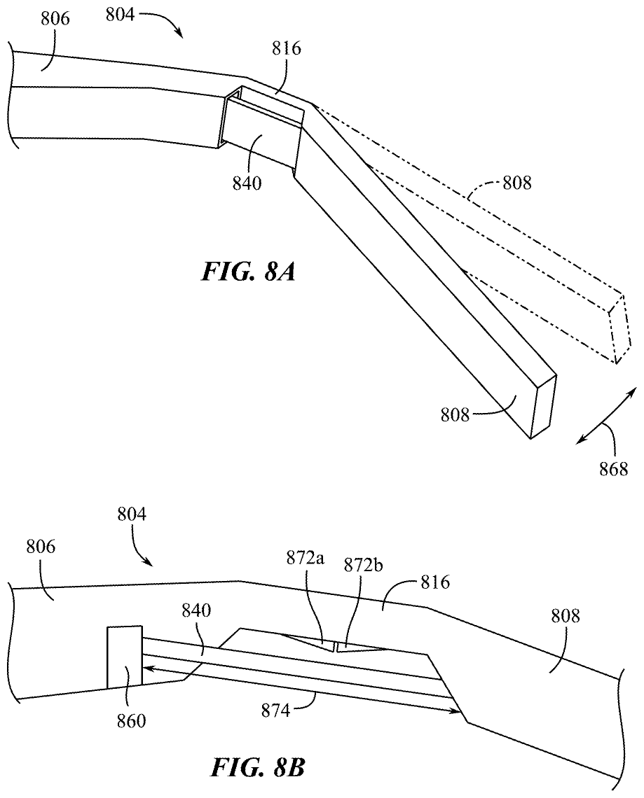

FIG. 8A illustrates another example of a securement arm 804, including a first portion 806 and a second portion 808 coupled to the first portion 806 at a joint 816. The joint 816 can be a flexible member, such as a living hinge, that allows the second portion 808 to move relative to the first portion 806. In one example, the second portion 808 can rotate or pivot relative to the first portion 806, such as along direction 868. In one example, the second portion 808 can rotate along direction 868 between a first position shown in solid lines, and a second position shown in dotted lines. The first position can be an inward position, such as an innermost position or a position conforming to a curvature of the user's head. The second position can be an outward position, such as an outermost position or a position allowing donning and doffing of an associated device. In one example, the second portion 808 can have a resting position, which may be the first position illustrated in FIG. 7A.

FIG. 8B illustrates a cross-sectional view of the securement arm 804 and in the first, resting position. Referring to FIGS. 8A-8B, the securement arm 804 can include a biasing member 840 providing a force resisting movement of the second portion 808 from the first position to the second position. In one example, the biasing member 840 can extend between the first portion 806 and the second portion 808, such as across the joint 816, to resist a movement of the second portion 808 away from the resting position. Referring to FIG. 8B, the securement arm 804 can include a stop to limit inward rotation of the second portion 808, such as towards a frame of an associated device (e.g., frame 102, 202, or 302). In one example, an engagement of the second portion 808 with the stop can define the resting position of the second portion 808 relative to the first portion 806. For instance, the stop can be defined by first and second tabs 872a and 872b, with the first and second tabs 872a, 872b abutting to define the resting position of the second portion 808. When the second portion 808 is rotated outwardly, the second tab 872b can move (e.g., rotate) away from the first tab 872a to define a gap between the tabs.

With continued reference to FIG. 8B, the biasing member 840 can be an elastic member having a length 874. In one example, the biasing member 840 can be a stretchable member (e.g., a stretchable cord or ribbon) that elastically increases in dimension (e.g., in length 874) as the second portion 808 rotates from the first position to the second position. As shown, the securement arm 804 can include an adjustment member 860 configured to adjust the biasing member 840. In one example, the adjustment member 860 can be configured to adjust the length 874 of the biasing member 840. For instance, the adjustment member 860 can be a screw or bolt that takes up a length of the biasing member 840 when rotated in a first direction. In one example, reducing the length of the biasing member 840 can tighten the second tab 872b against the first tab 872a, thereby increasing a tension or preload of the biasing member 840. Conversely, the adjustment member 860 can add length to the biasing member 840 when rotated in an opposite second direction, reducing the tension and preload of the biasing member 840. In this manner, the adjustment member 860 can be configured to adjust a tension in the biasing member 840.

Any of the features, components, and/or parts, including the arrangements and configurations thereof shown in FIGS. 8A-8B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 8A-8B.

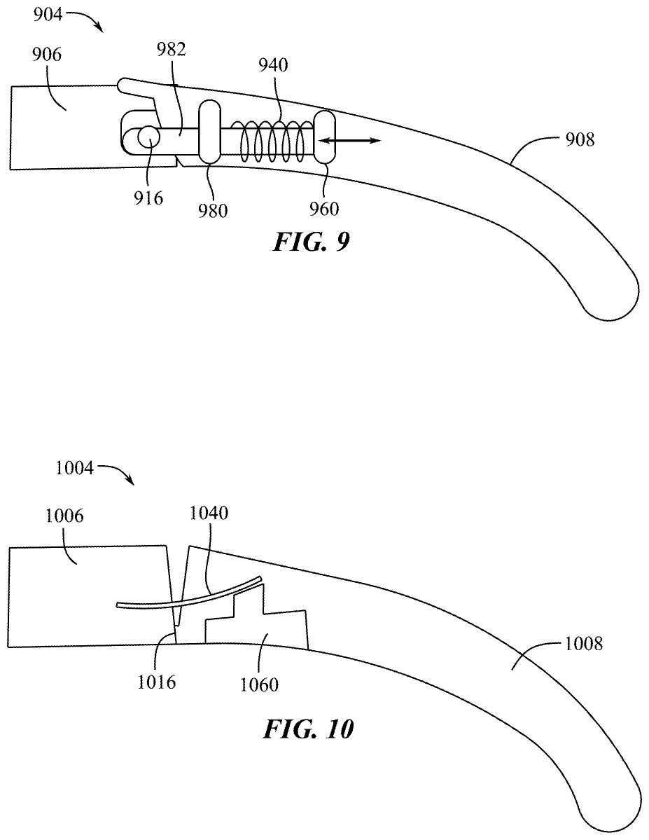

FIG. 9 illustrates another example of a securement arm 904, including a first portion 906 and a second portion 908 coupled to the first portion 906 at a joint 916. The securement arm 904 can also include a biasing member 940 and an adjustment member 960 configured to adjust the biasing member 940. For example, the biasing member 940 can be a spring, and the adjustment member 960 can be a screw, bolt, or nut. In one example, the biasing member 940 can be a compression spring positioned between at least a portion of the adjustment member 960 and a post 980, such as about a shaft 982 extending from the adjustment member 960 and through the post 980 to the joint 916, although other configurations are contemplated, including, for example, a tension spring. In one example, the post 980 can be fixed to the second portion 908, and the adjustment member 960 can be coupled to the joint 916.

When the second portion 908 is rotated outwardly relative to the first portion 906, the biasing member 940 can be compressed between the post 980 and the adjustment member 960, thereby biasing the second portion 908 inward. In one example, the adjustment member 960 can adjust the spring rate of the biasing member 940. For instance, the adjustment member 960 can be positioned closer to the post 980 to increase the spring rate of the biasing member 940. Conversely, the adjustment member 960 can be positioned further away from the post 980 to decrease the spring rate of the biasing member 940. In one example, the adjustment member 960 can be selectively positioned along the shaft 982, such as threaded onto the shaft 982, although other configurations are contemplated. In this manner, the adjustment member 960 can adjust the preload of the biasing member 940 by compressing or depressing the spring at a starting position.

Any of the features, components, and/or parts, including the arrangements and configurations thereof shown in FIG. 9 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 9.

FIG. 10 illustrates another example of a securement arm 1004 including a first portion 1006, a second portion 1008 coupled to the first portion 1006 at a joint 1016, a biasing member 1040, and an adjustment member 1060 configured to adjust the biasing member 1040. As shown, the biasing member 1040 can be a flat spring that bends across the joint 1016 to bias the second portion 1008 inwardly against a user's head. In such examples, the adjustment member 1060 can create the bend in the biasing member 1040 to provide the biasing force. In one example, the adjustment member 1060 can be a swappable piece to adjust the preload or tension of the biasing member 1040. For instance, the user can swap the adjustment member 1060 out with another adjustment member having different dimensions to adjust the bend (and preload) in the biasing member 1040, as desired.

Any of the features, components, and/or parts, including the arrangements and configurations thereof shown in FIG. 10 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 10.

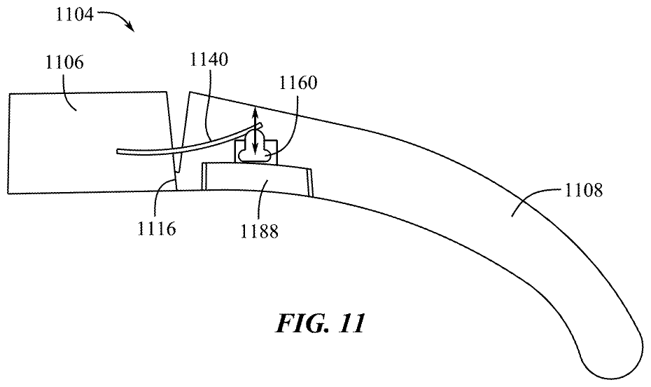

FIG. 11 illustrates another example of a securement arm 1104 including a first portion 1106, a second portion 1108 coupled to the first portion 1106 at a joint 1116, a biasing member 1140, and an adjustment member 1160 configured to adjust the biasing member 1140. The biasing member 1140 can be a flat spring that bends across the joint 1116 to bias the second portion 1108 inwardly against a user's head. In one example, the adjustment member 1160 can adjust the bend in the biasing member 1140 to tailor the biasing force, as desired. As one example implementation, the adjustment member 1160 can include a screw or bolt configured to adjust the spring rate of the biasing member 1140. For instance, as shown, the adjustment member 1160 can be screwed or threaded into the second portion 1108 to increase the spring rate of the biasing member 1140. Conversely, the adjustment member 1160 can be screwed or threaded out of the second portion 1108 to decrease the spring rate of the biasing member 1140. In one example, the securement arm 1104 can include a cover 1188 that conceals the adjustment member 1160 and/or protects the adjustment member 1160 from undesired adjustment.

Any of the features, components, and/or parts, including the arrangements and configurations thereof shown in FIG. 11 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 11.

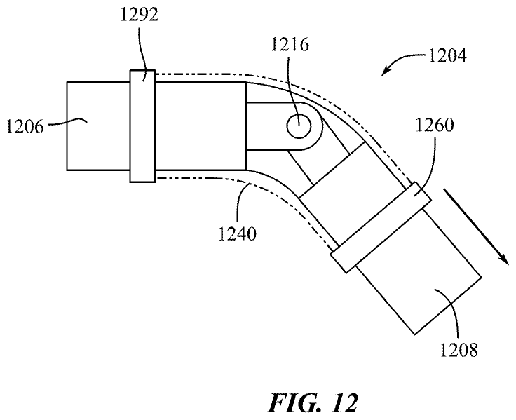

FIG. 12 illustrates another example of a securement arm 1204 including a first portion 1206, a second portion 1208 coupled to the first portion 1206 at a joint 1216, a biasing member 1240, and an adjustment member 1260 configured to adjust the biasing member 1240. In one example, the biasing member 1240 can include a fabric material. In such examples, the fabric can be woven in a bent position (e.g., as illustrated in FIG. 12) to resist bending of the securement arm 1204, such as to resist outward rotation of the second portion 1208 away from the user's head.

As shown, the biasing member 1240 can be coupled to the first portion 1206 via a fixed collar 1292, and coupled to the second portion 1208 via the adjustment member 1260. The adjustment member 1260 can slide along the second portion 1208 to increase a tension in the fabric over the joint 1216. In one example, the adjustment member 1260 can be locked in a selected position along the length of the second portion 1208. For instance, the adjustment member 1260 can be locked in position with a set screw, detents, a clamping collar against the perimeter of the second portion 1208, or other mechanisms. In one example, the adjustment member 1260 can be a collar configured as a spring to clamp against the second portion 1208.

In one example, the inside of the fabric biasing member 1240 can be filled with foam, such as to limit creasing of the fabric and/or to limit the fabric from touching the joint 1216. In such examples, the foam can further resist an outward rotation of the second portion 1208 away from the user's head.

Any of the features, components, and/or parts, including the arrangements and configurations thereof shown in FIG. 12 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 12.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER®ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not intended to be exhaustive or to limit the examples to the precise forms disclosed. It will be apparent to one of ordinary skill in the art that many modifications and variations are possible in view of the above teachings.

What is claimed is:

1. A securement arm for a wearable device, comprising:
a first portion;
a first electronic component disposed in the first portion;
a joint;
a second portion coupled to the first portion at the joint;
a second electronic component disposed in the second portion, the first electronic component electrically coupled to the second electronic component through the joint;
a biasing member providing a biasing force resisting a movement of the second portion relative to the first portion; and
an adjustment member configured to adjust the biasing force.

2. The securement arm of claim 1, wherein the adjustment member comprises a body slidable along a length of one of the first portion or the second portion to adjust the biasing force.

3. The securement arm of claim 2, wherein:
the biasing member has a spring rate; and
the body comprises a block slidably coupled to the one of the first portion or the second portion to adjust the spring rate.

4. The securement arm of claim 3, wherein:
the biasing member comprises a bending beam having an effective length; and
the effective length is adjusted based on a position of the block along the one of the first portion or the second portion.

5. The securement arm of claim 2, wherein a movement of the body away from the joint decreases the biasing force.

6. The securement arm of claim 1, wherein:
the joint comprises a living hinge; and
the biasing member comprises an elastic member.

7. A head-mountable device comprising the securement arm of claim 1, wherein:
the securement arm is a first securement arm; and
the head-mountable device further comprises a frame and a second securement arm, the first securement arm extending from the frame and the second securement arm extending from the frame.

8. The head-mountable device of claim 7, wherein:
the joint is a first joint; and
the head-mountable device further comprises:
a second joint; and
a third portion coupled to the second portion at the second joint.

9. An electronic device comprising:
a viewing frame;
a window disposed in the viewing frame;
a projector configured to direct light toward the window; and
a securement arm extending from the viewing frame, the securement arm comprising:
a first portion including a first electronic component;
a joint;
a second portion including a second electronic component, the second portion coupled to the first portion at the joint, the second portion having a resting position;
a biasing member having a preload and configured to resist a movement of the second portion away from the resting position; and
an adjustment member configured to adjust the preload.

10. The electronic device of claim 9, wherein the biasing member is configured to resist an outward rotation of the second portion away from the viewing frame.

11. The electronic device of claim 9, wherein:
the biasing member comprises a flat spring having a spring rate; and
the adjustment member comprises a block slidably coupled to one of the first portion or the second portion to adjust the spring rate.

12. The electronic device of claim 9, wherein:
the biasing member comprises an elastic member having a length; and
the adjustment member is configured to adjust the length.

13. The electronic device of claim 9, wherein:
the biasing member has a spring rate; and
the adjustment member comprises a screw configured to adjust the spring rate.

14. The electronic device of claim 9, wherein the adjustment member is configured to adjust a tension in the biasing member.

15. A head-mountable device comprising:
a frame;
an optically transparent window secured to the frame;
a first securement arm extending from the frame; and
a second securement arm extending from the frame, each of the first securement arm and the second securement arm comprising:
a first portion coupled to the frame;
a second portion;
a joint coupling the second portion to the first portion;
a biasing member providing a force resisting a rotation of the second portion away from the frame; and
an adjustment member configured to adjust the force.

16. The head-mountable device of claim 15, further comprising:
wherein the adjustment member comprises a body selectively positioned along a length of one of the first portion or the second portion to adjust the force; and
a locking mechanism releasably securing the body in a selected position along the length.

17. The head-mountable device of claim 15, wherein:
the joint comprises a fixed pivot point for rotation of the second portion relative to the first portion; and
the biasing member comprises a spring extending across the pivot point.

18. The head-mountable device of claim 15, wherein:
the joint comprises a living hinge; and
the biasing member comprises a plate or a wire resisting an outward rotation of the second portion away from the frame.

19. The head-mountable device of claim 15, further comprising a stop to limit inward rotation of the second portion towards the frame.

20. The head-mountable device of claim 19, wherein:
an engagement of the second portion with the stop defines a resting position of the second portion relative to the first portion; and
the biasing member resists a movement of the second portion away from the resting position.
